(19) United States
(12) Patent Application Publication
(10) Pub. No.: US 2014/0130558 A1
(43) Pub. Date: May 15, 2014

(54) Retaining device to be attached at the end of a steering wheel lock

(71) Applicants: Pingjun Qi, Brooklyn, NY (US); Xuhao Qi, Brooklyn, NY (US)

(72) Inventors: Pingjun Qi, Brooklyn, NY (US); Xuhao Qi, Brooklyn, NY (US)

(21) Appl. No.: 13/676,289

(22) Filed: Nov. 14, 2012

(51) Int. Cl. E05B 17/00

(52) U.S. Cl. 70/431

(57) ABSTRACT

A retaining device including a group of circular placed thorns and a mechanism functioned to push out, lock, unlock and restore the thorns. The retaining device is mounted at the end of the extendable sleeve member of a bar shaped steering wheel lock. The thorns are unlocked and restored automatically when the extendable sleeve member is restored.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to steering wheel lock attachments to be mounted at the end of a bar shaped steering wheel lock, and more particularly to an anti-theft attachment that enhances the reliability of steering wheel locks and prevents the driving room from being accessed by any unauthorized personnel.

2. Description of the Prior Arts

In most cases, the end of an automobile steering wheel lock is simply covered by a hard rubber cover. In a few more advanced designs, the end of a steering wheel lock is made to accomplish a better looking, for example to make the anti-theft device look like a baseball bat. However, the design does not add value to the anti-theft feature of the steering wheel lock. In order to increase the reliability of the anti-theft device, another structure has been disclosed in which a warning light has been used to replace the traditional end cover. However the light is not very useful because a visual signal does not prevent the theft from entering the driving room.

### SUMMARY OF THE INVENTION

The present invention provides an improved steering wheel lock end cover that enhances the reliability of steering wheel locks. The steering wheel lock attached with such retaining device is mounted downward such that the retaining end is placed between the front door and the driver's seat. Thus any unlocking process can only be done outside the vehicle and with the door remains open. Otherwise the deployed thorns become a potential threat to the personnel who tries to enter the driving room and even to who is already sitting on the driver's seat. Also, the automatic restoration of the thorns after unlocking the steering wheel lock eliminates any inconvenience to the users.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective illustration of the retaining device according to the present invention.

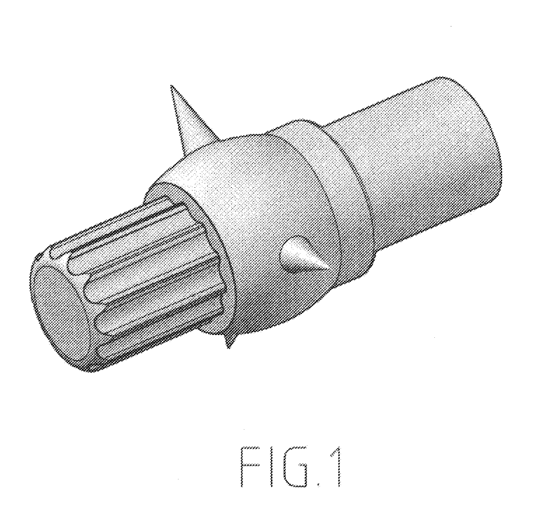

FIG. 2 is a perspective illustration of the retaining device according to the present invention in use.

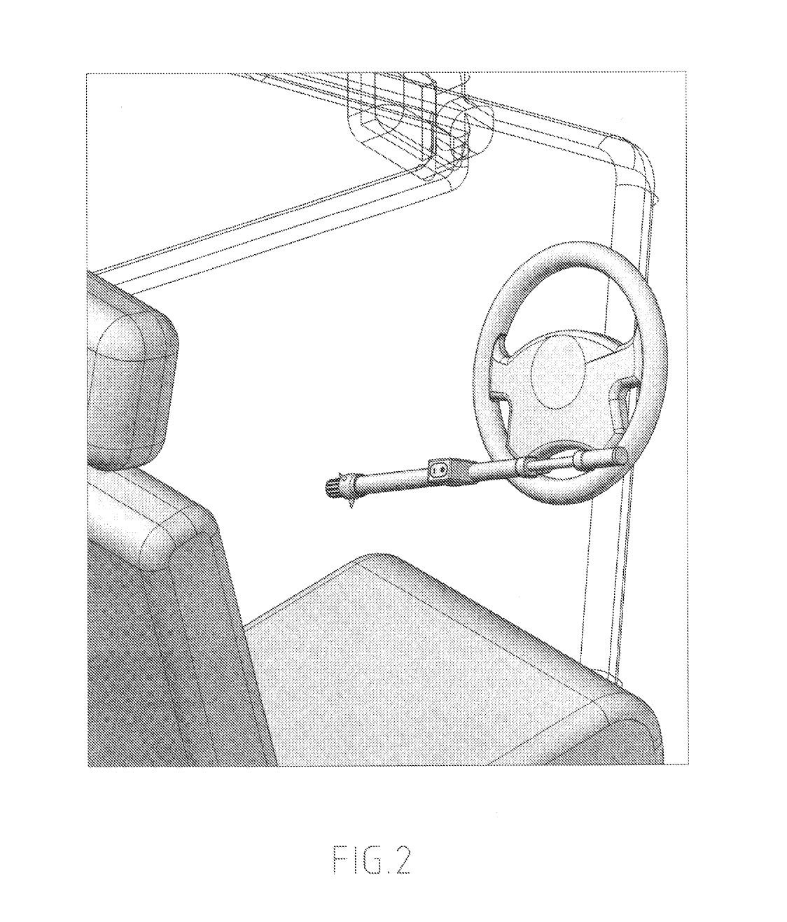

FIG. 3 is a structural illustration of the retaining device according to the present invention in the locked position in which the thorns are pushed out.

FIG. 4 is a structural illustration of the retaining device according to the present invention in the unlocked position in which the thorns are restored.

### DETAILED DESCRIPTION OF THE INVENTION

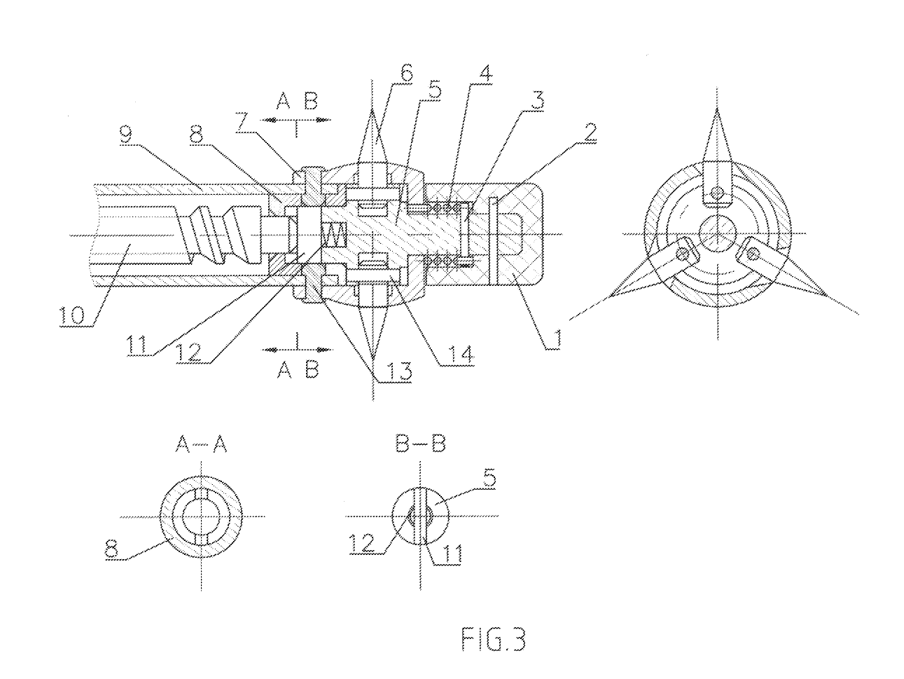

Referring initially to FIG. 3, in which the movable thorns 6 are controlled by the knob 1. A metal pin 2 engages the knob 1 with the shaft 5. Another pin 3 secures one side of the torsion spring 4 on the shaft 5. The torsion spring 4 restores the thorns 6 automatically when the retaining device is unlocked. The three thorns 6 secured on the shaft 5 by three metal pins 14 can be either pushed out or restored. The shaft 5 built within the device cover 7 is the supporter of the thorns 6. A slot for the slider 11 is cut inside the sleeve member 8. When the thorns 6 are pushed out, the slider 11, of which one side is engaged with the shaft 5, slides into the slot built within the sleeve member 8 and thus locks the thorns 6 in position. A spring 12 is designed to push the slider 11 into the slot when deploying retaining device. A rivet 13 secures the retaining device on the end of the protective sleeve member 9 of the steering wheel lock.

The steering wheel lock should be mounted on a steering wheel such that the retaining device attached on the end of the steering wheel lock is placed between the door and the driver's seat. When the steering wheel lock is deployed, the interior rod 10 within the steering wheel lock is pulled out from the sleeve member 8. The thorns can then be pushed out fully by rotating the knob 1. In such instance, the slider 11 is pushed to the slot built within the sleeve member 8 by the spring 12 and thus blocks the shaft 5 along with the three attached thorns 6. The deployed retaining device therefore becomes a threat to any unauthorized personnel who try to enter the driver's room.

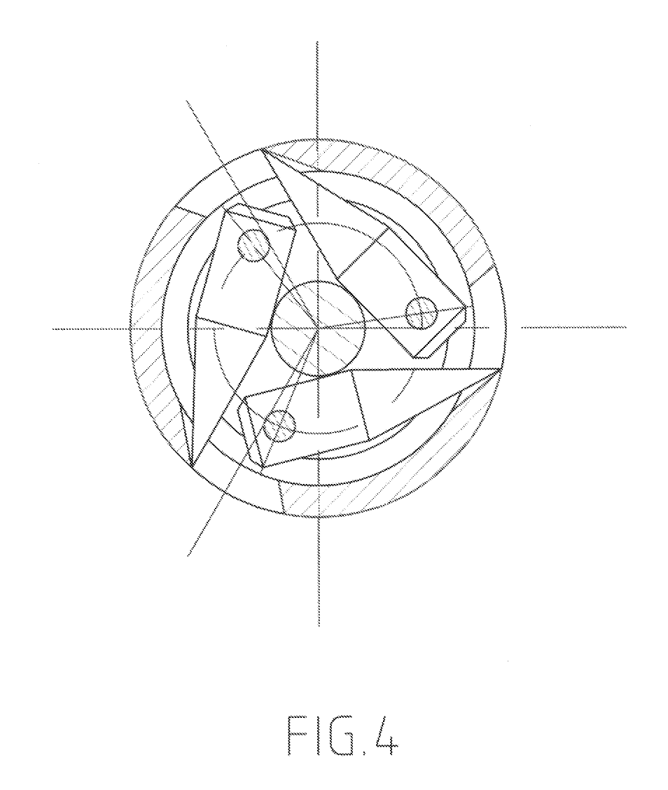

When the steering wheel lock is dismounted and restored, the end of the interior rod 10 goes back into the sleeve member 8 and pushes the slider 11 out of the slot allowing the shaft 5 to be unlocked and rotatable. The torsion spring 4 thus rotates the shaft 5 and restores the thorns 6 to original position as shown in FIG. 4.

What is claimed is:

1. A retaining device to be attached at the end of the extendable sleeve member of a steering wheel lock, with attached thorns that prevent the driving room from being accessed by thefts comprising:
a group of metal thorns built on a shaft and can be either pushed out or restored by rotating said shaft; and
a rotation locking mechanism that prevents said thorns from being pushed back by any external forces when the retaining device is deployed.

2. The automobile anti-theft device as claimed in claim 1, wherein said rotation locking mechanism includes a knob, a shaft, a slider, a normal spring, a torsion spring and a sleeve member. When said knob is rotated and said thorns are pushed out, said normal spring pushes said slider into a slot in said sleeve member and thus locks said shaft along with said three attached thorns.

3. The automobile anti-theft device as claimed in claim 1, wherein a design which unlocks said rotating locking mechanism and restores said thorns using the metal rod of the steering wheel lock is applied. While restoring the steering wheel lock, said metal rod goes back into said sleeve member and pushes said slider out of said slot and thus unlocks said shaft allowing said shaft to be unlocked and rotatable. Said thorns thus are restored back into the device case automatically when said shaft is rotated by said torsion spring.
